(19) United States
(12) Patent Application Publication
(10) Pub. No.: US 2023/0329148 A1
(43) Pub. Date: Oct. 19, 2023

(54) FLOW RATE MATCHING

(71) Applicant: BITSTRATA SYSTEMS INC., Saskatoon (CA)

(72) Inventors: Ian Robert Meier, Saskatoon (CA); Michael David Lockerbie, Saskatoon (CA)

(21) Appl. No.: 18/025,519

(22) PCT Filed: Sep. 21, 2021
(86) PCT No.: PCT/CA2021/051310

§ 371 Date: Mar. 9, 2023

Related U.S. Application Data
(60) Provisional application No. 63/221,088, filed on Jul. 13, 2021.
(60) Provisional application No. 63/082,187, filed on Sep. 23, 2020.

(51) Int. Cl. A01D 41/127; A01D 90/10

(52) U.S. Cl. CPC A01D 41/1272; A01D 90/10

(57) ABSTRACT

An apparatus, a system, and a method for identifying machines involved in a transfer event. Flow rate data for material transferred between machines is acquired. The identity of the machines and the amount transferred are derived from the flow rate data by assigning machines that have similar flow rate data signals during a window of time in which the flow rate changes significantly.

### CROSS REFERENCE TO RELATED APPLICATIONS

This application claims the benefit of the filing date under 35 U.S.C. § 119(e) of U.S. Provisional Application Ser. No. 63/221,088 filed on Aug. 13, 2021, and U.S. Provisional Application Ser. No. 63/082,187 filed on Sep. 23, 2020, the entire disclosures of which are incorporated by reference in its entirety.

### FIELD

The present disclosure relates to an apparatus, a system, and a method for calculating amounts and/or paths of material that are transferred during transfer events.

### BACKGROUND

Various vehicles or machines, particularly those designed for the purpose of transporting or conveying materials or cargo, exist with, or may be adapted to include integrated and/or on-board weighing capability, allowing for the measurement of a payload that is carried or transferred thereby. Such vehicles include single vehicles and tractor-trailer combinations. An example of a single vehicle may include a dump truck, a combine harvester, or a self-propelled feed mixer, and the like. An example of a tractor-trailer combination may include a tractor pulling a grain cart, a seed tender, a feed mixer, a manure spreader, a semi-truck with semi-trailer, and the like. Many of these vehicles have a mechanically or hydraulically powered discharge mechanism to cause a transfer of material from that machine, e.g., a hopper or container thereof, to another machine or storage location, such as a hoist in the case of a dump truck, or an auger or a conveyer in the case of a grain cart, a seed tender, a feed mixer, or a manure spreader.

A common problem for any material handling system involving multiple storage containers is tracking both the quantity of material transported as well as which machines, vehicles, and storage locations are involved in a transfer of material therebetween, referred to as a “transfer event.” In one attempted solution, a list of detected equipment is presented to the user, e.g., machine operator, and a selection by the user is used to determine the equipment used in the operation. Although an operator could record such information manually, operator error due to, for example, the monotony and exhaustion suffered by operators, leaves manually collected or selected data unreliable.

Another method of determining the source and destination of a transfer event is by detecting the proximity of machines involved in the transfer event. In an example, a wireless beacon device is placed on each piece of equipment, a receiver is located at or near the operator, and the system automatically selects from a list of allowed equipment types (for example, combine harvesters or perhaps trucks). The equipment associated with the beacon of highest signal strength is selected as the expected equipment used in an operation. As an example, while loading in the field, the combine harvester currently loading a particular grain cart can be detected as being located closest to that grain cart and thus assigned to the transaction. Similarly, while unloading, a truck receiving the grain can be detected as the closest truck and thus assigned to the transaction. Combined with the time, location, and event details (for example transactional weight) a detailed audit trail can be provided for field operations. For a simple setup involving few machines (e.g., fewer options) a proximity system may function adequately. However, when multiple machines or storage locations are in close proximity, the accuracy of such a system deteriorates, resulting in incorrect decisions and determinations. It is often the case, particularly for large farming operations, to have multiple combines operating side by side, numerous tractors pulling grain carts continuously arriving at each combine to offload grain, and numerous tractor trailer stationed at a receiving area to receive the grain cart loads from the field.

Another method includes inserting tracking devices into each stream of material. Tracking devices involve an additional layer of logistics and may be expensive to both implement and maintain. Thus, there exists an unmet need for a traceability system that automatically and accurately keeps records of how transfers of materials occur.

### BRIEF DESCRIPTION OF THE DRAWINGS

The above and other objects, features and advantages of the present disclosure should be more apparent from the following detailed description taken in conjunction with the accompanying drawings:

FIG. 1A and FIG. 1B depicts examples of combine harvesters and grain carts.

FIG. 2 depicts a flowchart for calculating an amount of material transferred between a plurality of sources and destinations in a commodity handling system according to an embodiment.

FIGS. 3A and 3B depict example flow rate data signals.

FIGS. 4A, 4B, and 4C depict example cross correlations of flow rate data signals.

FIGS. 5A, 5B, and 6 depict examples of possible component configurations according to an embodiment.

FIG. 7 depicts an example system for calculating an amount of material transferred between a plurality of sources and destinations according to an embodiment.

FIG. 8 depicts a state machine for the controller of FIG. 7 according to an embodiment.

FIG. 9 depicts an example flow sensor of FIG. 7 according to an embodiment.

FIG. 10 depicts an example user interface of a display of FIG. 7 according to an embodiment.

### DETAILED DESCRIPTION

Aspects of the disclosed embodiments provide an apparatus, a system, and a method for acquiring flow rate measurements from multiple machines, detecting changes in the flow rates for the machines, and determining the machines involved in a transfer event by selecting machines with similar shaped flow rate signals.

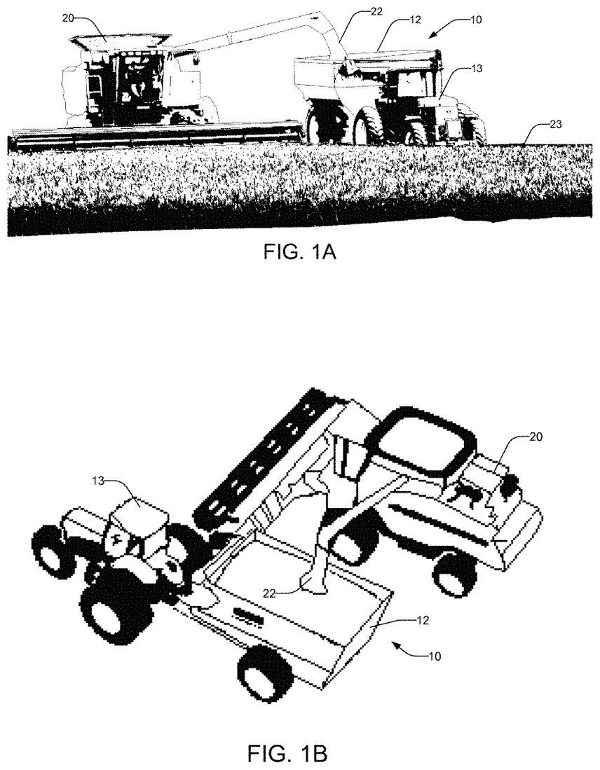

FIGS. 1A and 1B depict a combine harvester 20 loading grain 22 from a field of grain 23 into a grain cart 10. Grain carts 10 are large-capacity pull-type trailers with a container 12 for grain 22, a built-in discharge auger 18, and capacities currently as high as 2,000 bushels or larger. A tractor 13 with grain cart 10 typically shuttles grain 22 from a combine harvester 20 in a field to a grain truck 24 located at the edge of the field. The grain carts 10 are typically loaded by or from a combine harvester 20, and then unloaded into one or more trucks 24, with combine harvesters 20 and trucks 24 typically utilized with one or more grain carts 10 to harvest fields of grain. The use of grain carts 10 dramatically increases harvest efficiency, allowing combine harvesters 20 to operate nearly continuously with no need to stop to unload, especially since grain carts 10 can be loaded from combine harvesters 20 while the combine harvesters 20, and the grain cart 10 they are loading, move across the field together. While the grain cart 10 is away from the combine harvester 20, the combine harvester may continue to harvest the field, relying on its built-in hopper or grain container to buffer the harvested grain. After unloading to a waiting truck 24, the grain cart 10 can then head back to receive grain from a (not necessarily the same) combine harvester 20.

Weighing systems for grain carts allow the tracking of yields, and help ensure that operators can accurately fill the truck to capacity with little risk of incurring fines for overweight loads. Grain carts make the use of combine harvesters more efficient; weighing systems can help make the whole process more efficient and provide data for tracking and tracing of yields. The implementation of data-driven farm management allows operators to make better decisions that results in higher productivity, profitability, and lower costs. Applications in data-driven farm management goes beyond harvest and production. Collection of accurate data regarding yields and tracking can influence the entire food supply chain. Identifying where and when certain materials are gathered and how the materials are transferred from one machine to another is a key data point for data-driven farm management. Yield data and transfer data are useful tools for making crop management decisions, but becomes irrelevant when it is not accurate or reliable. During transfer events, lack of identification of the harvesting equipment (for example, a combine harvester and one or more trucks) involved in grain transactions limits the usefulness of the collected management information. If the exact setup and operation is known, the source, destination, and amount of material may be derived using manual tracking methods. Machines, however, breakdown, are replaced, substituted for, and may be operated manually which generates uncertainties as opposed to a fully automatic operation. Existing methods use proximity measurements to infer which machines are part of a transfer. However, when multiple machines or storage locations are in close proximity, accuracy deteriorates, resulting in incorrect decisions and data errors.

The disclosed embodiments provide a system and method to automatically track transfer events using flow rate measurements for each machine involved in the transfer event. The system monitors flow rate sensors in each machine that produce a signal that varies with a flow rate of the material that is transferred. The system receives the signals and detects changes in the flow rates. The detected change values are used to identify windows of time that include a beginning or end of a transfer event. The signals for the windows for the flow rate data are compared for each machine. The machines are ranked and assigned based on the similarity of the signals in order to determine a path of the transfer of the material including a source and a destination. The transfer events are thus defined. An amount of material that is transferred may also be determined.

In an example of the operation of the disclosed system and method, there are multiple combine harvesters unloading into multiple grain carts. A combine harvests grain and deposits the grain in an integrated tank or hopper. The tank or hopper includes an unload auger that unloads the hopper into a vehicle such as a grain cart. The combine harvesters and grain carts each include a sensor that measures the flow of material into (ingress) or out (egress) of the respective machine. In this example, the flow of grain out of a combine harvester is measured by a sensor attached to the auger, while the flow of grain into a grain cart is measured using a weight scale. In a combine harvester, a flow sensor is attached to the unload auger of the combine harvester that produces a signal that increases as the flow rate through the auger increases.

The increase in flow rate indicates a beginning of an unload event in which the combine harvester unloads into the grain cart. In this example, the grain cart includes a built-in scale that provides weight signal measurements. The flow of grain into the grain cart may be derived by calculating the equivalent of a derivative of the weight signal such as by successive differencing. The flow rate into the grain cart also increases at the beginning of the unload event with a delay between the two flow rate signals that represents the time it takes the grain to fall from the auger spout into the grain cart's tank. When a significant increase in the grain cart weight is detected, a cross correlation is performed between a time window of the grain cart flow rate signal and similar windows for all other combine harvester flow sensors detected in the same period of time. For each sensor, a cross correlation is calculated, and any cross correlation with a maximum occurring within a window offset by the expected delay is selected and ranked based on the magnitude of the maximum. The minimum rank number (largest maximum) is used to identify/select the specific combine harvester/grain cart combination that is involved in the transfer. When the grain cart's weight stops increasing, the cross correlation is repeated and each combine harvester's rank number associated with the start of the transfer is incremented by or otherwise combined with the newest rank number representing the end of the transfer. The lowest total rank number is used to identify the combine harvester involved in the transfer. The identification of the combine harvester is recorded along with the weight filled (the difference in weight before and after the fill), and data identifying the grain cart, current field, or both.

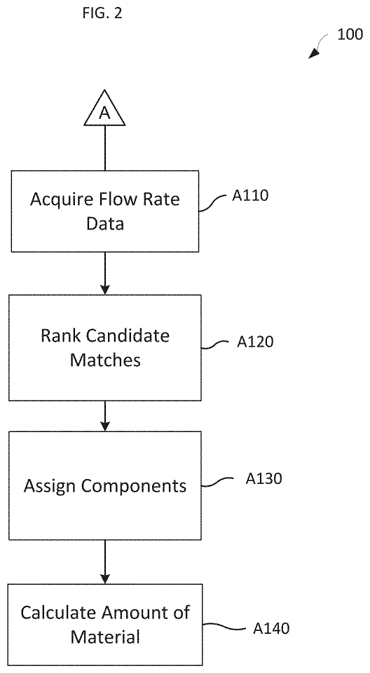

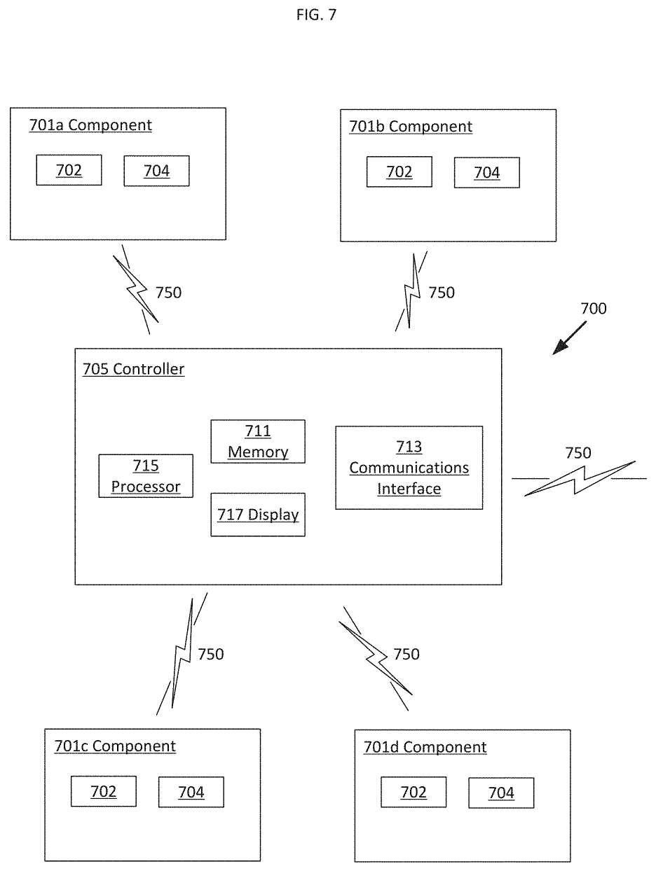

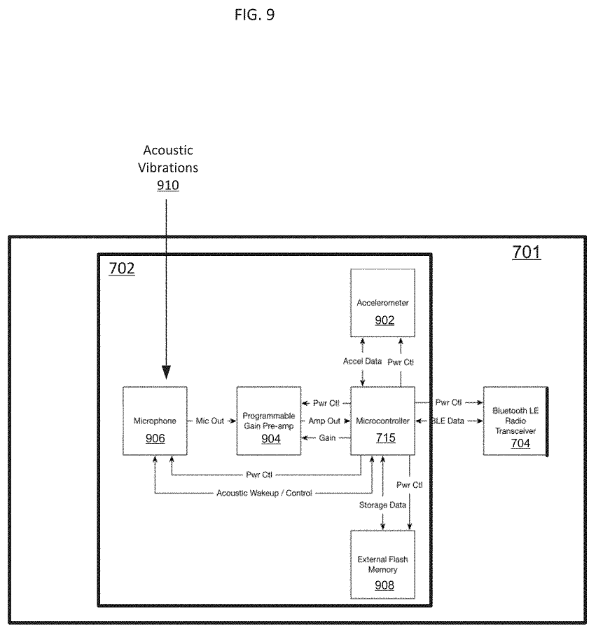

FIG. 2 depicts an example method for calculating an amount of material transferred between a plurality of sources and destinations in a commodity handling system. The method may be performed by any combination of the components indicated in FIG. 7 or 9. In an embodiment, the components may include both flow sensors and processing units. The flow sensors use sensors that are embedded with or attached to the components. The sensors produce a signal from which a flow rate, or some other value related to flow rate, may be derived. The one or more processing units receive one or more of these signals in order to detect changes in flow rates and match the flow rate data between flow sensors to determine the path the material is taking. Additional, different, or fewer acts may be provided. The acts are performed in the order shown or other orders. The acts may also be repeated. Certain acts may be skipped.

At act A110, material flow rates are measured by flow rate sensors for each of the plurality of respective sources and respective destinations involved in a transfer of material. Components in the commodity handling system may be either sources, destinations, or both based on a nature of the transfer. As an example, a grain cart is a destination in the field when receiving from a combine harvester but is a source when delivering its load to a truck or storage bin. Each flow rate sensor periodically makes measurements that are related to the flow rate of material into (ingress) or out (egress) of a respective container. The sensor may be any sensor producing a signal related to flow rate, such as but not limited to, a force plate in the stream of grain, an on-board scale that detects/measures the change in weight of material within a container, a vibrational sensor in the stream of grain, or an acoustic sensor detecting the sound level due to grain flow. The flow rate (also known as volume flow rate, rate of material flow, volume velocity, or discharge) is the volume of material that passes per unit time. The flow rate may also be measured using the mass or weight of material instead of volume. If the density of the material is known, then a conversion may be used.

When a container supports integrated weighing capability, such as with one or more onboard scales, flow in (ingress) or out (egress) of the container may be detected by detecting an increase or decrease of weight of the material in the container. A weigh sensor may include either load cells or weigh bars. In one configuration, there is one weight sensor for each wheel and one for the tow bar or hitch. In another configuration, there are multiple weight sensors spread out around the container. At a base configuration, standard weigh scale functions include zeroing; tare; and net/gross toggle. During operation, the flow rate may be derived from the increase or decrease of weight over time. Weight sensors, however, may provide inaccurate data. Weight measurements may be compromised by forces that originate either on-cart (auger operation) or from accelerations due to drops and impacts with obstacles on uneven terrain. As such, alternative sensors such as vibrational sensors or acoustic sensors may be used in addition to, or instead of, the weight sensors to increase accuracy.

In an embodiment, an acoustic flow sensor is configured to monitor the flow of grain into or out of a container where onboard weighing is not provided or it is difficult to determine whether weight is increasing or decreasing due measurement dynamics from the motion of the container. The ingress flow is detected by positioning the acoustic flow sensor inside a container and orienting the acoustic flow sensor such that a microphone, or other auditory detector, responds to the sound of grain arriving in the container. Egress flow is detected by positioning the acoustic flow sensor near the location where the grain is discharged and orienting the acoustic flow sensor such that the microphone responds to the sound of grain arriving at the receiving hopper or container. An individual acoustic flow sensor may be configured or associated with either ingress or egress transfers, though there may be cases whether a single acoustic flow sensor can detect both ingress and egress.

In an embodiment, a flow sensor that combines acoustics and vibrations may be used. Data corresponding to both acoustics and vibrations is detected and transmitted. Receiving devices, such as a smartphone, tablet, or embedded computing unit may use the measurements, along with knowledge of the type of machine to which the flow sensor is attached, to determine whether grain is flowing in or out of the specific machine associated with the advertised data. The acoustic/vibrational flow sensor detects both acoustics and vibrations. When grain is transported from one location to another, either through gravity or a conveyor, each kernel of grain creates an impulse of energy when the kernel strikes a container or pile of grain. The frequency spectrum of a perfect impulse is wideband, and as such contains equal intensity at all frequencies. A kernel of grain does not create a perfect impulse, but does contain significant high-frequency components. A stream of kernels causing impulses at random times results in an acoustic signature resembling white noise, that sounds like a hiss. The high frequency components are used to distinguish the grain flow signature from other lower-frequency components generated by farm machinery. The microphone of the flow sensor is oriented such that it is sensitive to this sound. The high frequency content of the signal may then be analyzed. The spectral power of the signal increases with the flow rate, though it may not be accurate enough to determine an accurate measurement of the flow rate itself. However, the detection of the change in the flow rate allows for techniques such as flow rate correlation with other sensors as a way of determining the machines involved in a transfer. In addition, an accelerometer may be used as a contact microphone to sense grain flow directly, when the accelerometer is mounted within the grain flow path, or attached to a surface directly or indirectly within the grain flow path.

In an embodiment, a mobile device such as a tablet or smartphone, or other computer device equipped with a microphone and/or vibration sensor may be installed inside or outside the cab associated with the machine. The sensors may be used independently, or in combination, to perform a flow rate measurement. Because the device may be installed in the cab, or at a location not optimally positioned to receive the acoustic signal relating to the grain flow, the device may perform measurements over a spectrum including the machine and engine noise as well, as an increase in these measurements may both correspond to a transfer occurring, and a decrease corresponding to a transfer ceasing. The device may also be equipped with a front-facing camera, from which the operator's angular head position may be detected. The change in the average yaw angle of the operator's head may also be an indicator of flow, as during a transfer the operator's head will typically rotate in the direction that the physical transfer is occurring so that the operator may observe the transfer, e.g., in order to ensure the transfer occurs safely and without spillage of grain. The use of a mobile device may be advantageous as it requires no specialized hardware, and the device may additionally provide relevant information to the operator, that may or may not be modified when a transfer is occurring. Such a modification may include, but is not limited to, providing to the operator a cumulative total being transferred. A mobile device may be installed in, or on, multiple pieces of equipment, including, but not limited to, the combine cab, grain cart tractor cab, truck cab, grain bagger tractor cab, swing-away auger tractor cab, straight auger, planter tractor cab, seed tender, the vehicle towing the seed tender, etc. Each of the devices may also receive data which is more directly representative of flow, such as from a scale. The devices may also be furnished with GPS capabilities, allowing the location of the transfer to be determined and shared with other devices not supporting GPS. Each of the devices may collect and store sensor data in its internal storage, and then may further upload the sensor data, or derivations therefrom, to a remote server for analysis or other purpose, such as long term storage. The remote server may then perform a cross-correlation or other analysis of sensor flow data from various sources to determine the identify of machines involved in the transfer as a post-processing operation. The sensor data may be at a high resolution, e.g., the sampling rate, frequency range, and/or data precision may be HD or high definition, for example 100 kbps or higher as the amount of storage available on standard mobile devices and in cloud storage is generally large enough to support the type of data collected. An example of this data may include the entire audio signal, vibrational signal, and head tracking data collected during a transfer event, for example including some buffer time before and after the transfer event.

The sensor data collected by a mobile device may also be communicated in the field directly or indirectly to, for example, other mobile devices in order to select the identity of devices involved in a transfer in real time, without requiring internet connectivity, as would typically be required when utilizing a remote server for the analysis. The in-field communication may use different methods, including Wi-Fi, Bluetooth, Bluetooth Low Energy (BLE), or any other wireless method. The use of BLE may be performed using either connection-based, or advertising-based methods. A connection-based, point-to-point (unicast) method may provide for greater data capacity at reduced range and increased complexity. The complexity is further increased when multiple machines are in communication range with one another, as the number of possible connections increases in proportion to the square of the number of machines. An advertising-based method provides for each device to broadcast the state of one or more sensor measurements, and any in-range device may receive them. This allows for a simpler multicast communication protocol and supports greater wireless range due to a full connection being unnecessary. One way to advertise information using BLE is to use the manufacturer-specific BLE data tag followed by a 16-bit manufacturer's identifier, followed by the data. However, the tag may not be supported by all platforms providing BLE capability, and the manufacturer's identifier reduces the capacity of the limited-capacity advertising packet by two bytes. Further, the device may advertise a 16-bit or 128-bit service id unique to the device type or manufacturer, so that receiving devices may efficiently scan for only those devices advertising those identifiers. The ids are generally referred to as universally unique identifiers (UUIDs), and may be 128-bit except for 16-bit versions specifically registered by and reserved for manufacturers. An alternative method may be used that maximizes the data capacity of the advertising packet. The method involves transmitting a manufacturer-reserved 16-bit service UUID rather than a 128-bit one, and also transmitting one of or both the device name and another 128-bit service UUID. The device name and the 128-bit service UUID may be used to encode and transmit supplemental information and avoids the overhead lost due to the manufacturer id needed when transmitting manufacturer-specific data. The maximum data capacity using this improved method may involve transmitting only a 16-bit service UUID and using the device name for all other data, and not an additional 128-bit UUID, as each data element (name, UUID, etc.) requires two bytes (length and type) of overhead. However, this may require transmitting non-visible characters in the device name, and may make receiving the device name more complex. If a 128-bit service UUID is used to transmit 16 bytes of data, the device name may still be used for naming or identification purposes. A device associated with a machine supporting onboard weighing may transmit one or more of the following data relating to the transfer, including but not limited to the transfer type, information identifying the source or recipient of the transfer, a timestamp, a live weight, tare weight, starting weight, ending weight, transferred weight, a field associated with the grain, the acoustic power level in one or more frequency bands, the yaw angle of the operator's head, latitude, longitude, elevation, speed, heading, moisture, temperature, test weight, protein, oil content, or any other quality metric, quantity of material or grain not backed up to a remote server, etc. The data may be transmitted by one or more devices associated with the same machine, where the devices may be associated with one another by including data identifying each device or machine and external mapping configuration data associating the two pieces of identifying information with one another. As an example, a mobile device may advertise information identifying the machine on/in which it is installed, and information relating to a transfer, while another piece of hardware, such as a weighing or other sensor interface, may advertise information identifying the device or machine, as well as information relating to the sensors, and the identifier from the mobile device and the second hardware device may be associated using some external mapping information, allowing the data to be combined between the two devices. A device used on a machine not supporting onboard weighing may transmit any of the same information as a device installed on a machine supporting weighing, except the weight data, and may also transmit sensor data specific to the device or machine.

In an embodiment, mobile devices are installed inside the cab of one or more combines, grain cart tractor cabs, truck cabs, grain bagger tractor cabs, and swing-away auger tractor cabs. The grain cart device is typically scanning for advertisements from combines, trucks, or grain bags, and collecting the relevant sensor data. The other devices may advertise the relevant sensor values, such as acoustic level, vibration level, or head yaw angle, as well as the location of the device (latitude and longitude). When the grain cart device is not detecting a transfer, the grain cart device advertises its identity, the active field, moisture, temperature and test weight, and the amount of harvested grain currently not backed up to another device or server (unsynced). The information may be displayed on any other remote device. The remote device may display the received information to the operator, such as the current unsynced quantity of grain. If the grain cart device detects a transfer into the cart due to an increase in weight (loading event), the grain cart device begins advertising its identity, the transfer type (loading), the starting weight and timestamp of the load, the source machine of the transfer (if known), the field associated with the transfer, and the moisture, temperature, and test weight. The grain cart device then determines the source of the transfer using the sensor data collected from other devices using the maximum flow rate correlation, or the maximum sensor value related to flow rate. Once the source has been determined, the grain cart device extracts the location from the matching device associated with the transfer and advertises the source machine of the transfer, so that the relevant source machine may update its display to indicate the amount being transferred to the cart. If the grain cart device detects a transfer from the cart due to a decrease in weight (unloading event), the grain cart device begins advertising the same information as in a loading event, except the transfer type is unloading. The grain cart device determines the destination of the unload in the same manner as for detecting the source of the load, except, for example the devices may typically be installed in trucks or grain baggers, and the relevant destination device may update its display to indicate the amount being transferred as well as the current amount in the grain bag or on the truck. After either an unloading or loading event has completed, the grain cart device may advertise the total amount transferred, the type of transfer and the timestamp, so that other devices may update their local databases. The devices may update their databases provisionally, as the full details of the transfer may not be communicated using this communication mechanism, and then supplement the data once the full transfer details have been synced to the device through another data transfer mechanism.

In an embodiment, a device installed in a swing-away auger may operate similarly to a grain cart device, despite not being equipped with a scale. The swing-away auger device may indicate and advertise the beginning of a transfer (auger starting) by detecting an increase in acoustic or vibrational level as detected by its internal flow sensors, and may advertise the timestamp corresponding to when the auger started operating. It may further analyze the vibrational and acoustic data to determine when grain is flowing through the auger. Additionally, the device in the truck may advertise acoustic levels, as well as the weight carried by the truck based on incoming grain cart loads. The swing-away auger device may determine the truck involved in the transfer by performing a flow rate correlation between its own microphone and/or vibrational sensor, and the acoustic information collected from any trucks within wireless range, and choosing the maximum flow rate correlation. Once the correct truck has been detected, the device in the swing-away auger tractor may advertise the currently-selected bin as well as the identifier of the matching truck, so that the device in the truck may update its display to the current bin. The device may also collect the advertised weight from the matching truck as well as the transfer time to determine the flow rate of the auger, provided the entire weight is transferred. Multiple complete transfers may be used to determine an overall average flow rate. Once the swing-away device detects that the transfer has ended, the device may advertise both the amount of time the auger operated and the amount of time grain flowed through the auger, and the estimated transferred amount based on previous flow rate measurements. The times and the estimated weight may be detected and recorded by the matching truck. If the truck then moves, as detected by a change in GPS position, and then begins transferring again within a certain window of time, for example 10 minutes, or before moving a certain distance, for example 1000 feet, this may indicate that the load has been split between two bins. The truck's mobile device may split the load based on ratios of the amount of time the auger was operating, the grain was flowing, or the estimated transfer amount as reported by the swing-away device(s) associated with each transfer. The bins used for each portion of the load may be the bins announced by the associated swing-way device for each portion of the load. Once the truck moves from the unload location by more than a minimum distance, for example 1000 feet, its mobile device may automatically mark the truck as emptied to the bin received from the swing-away auger device.

Other different types of flow sensors may be used, alone or in combination, to measure the flow rate of material into or out of a container. Alternative methods may include, for example, impact-based sensing, radiation-based sensing, electromagnetic sensing, metering grain flow sensing, radar-based sensing, optical camera-based sensing, among others.

For impact-based sensing, material impacts an impact sensor, such as a plate, along the conveyance path. These are commonly used in a combine, where the grain is lifted up elevators on paddles and expelled from them at the top of the elevator by centrifugal force as the paddles rotate. The material is subjected to projectile motion until it contacts the impact sensor positioned across from the elevator. The impact sensor measures the flow rate of material by using a strain gage load cell attached to the impact plate. Material deflecting off the impact plate causes deformation in the structural components of the load cell and can be measured using a strain gage. Varying amounts of flow induce different amounts of strain on the impact sensor, which alter the electrical output signal of the sensor. The electrical signal is calibrated to correspond to different mass flow rates of material and adjusted to account for changes in elevator speed. After the material has deflected off the impact sensor, it is conveyed into a container in the case of a combine.

Radiation-based sensing utilizes a pair of sensors to determine the density of material in a flow stream. Each pair of sensors includes an emitter and detector that are installed opposite each other to enable the gamma source of the emitter to enter the detector. The detector measures the attenuation of gamma radiation as material flows between the sensor pair. When no material flow is present the detector measures the full strength of the radiation source, but as material density increases in higher flow rates there is a reduction in radiation signal strength. It is common to mount the sensor pair after an elevator when the material becomes airborne to limit mechanical inference of the measurement. Since the velocity of the material is fixed by the elevator rotational speed, the radiation signal strength is directly proportional to the mass flow rate of material.

For electromagnetic sensing, a magnetic field is created and channeled into the flow of dielectric material in a fixed volume. As the velocity or material density of material changes, the voltage generated is proportionally changed.

Optical beam-based mass flow sensors may be used to determine the volume flow of grain by detecting a beam pattern. For an example of optical-based sensing, the sensor includes a pair of opposed photoelectric sensors, e.g., an emitter and a receiver, that are rigidly fixed to the housing of the clean grain elevator. The emitter and receiver are positioned opposite each other. The emitter is configured to transmit a beam of light at the receiver. When the beam of light is unbroken, the receiver registers the emittance and outputs a high voltage response. Once the beam of light is broken (e.g., interrupted by grain or other material) between the emitter and receiver, the receiver is unable to sense any emittance and outputs a low voltage response. The duration of time that the response is at low voltage is related to a flow of grain or material. More complex configurations may be able to provide more accurate flow rate data.

Metering-based grain flow sensing uses a paddle wheel mounted in between the outlet of an auger into a hopper, which may feed another auger. The paddle wheel is sectioned into typically four or more fixed volumes. As material exits the elevator, it accumulates in one of the sections of the paddle's wheels. The section continues to fill with material until the volume reaches a predetermined sensor set-point. When the sensor is triggered, it indicates that the paddle wheel section is full and the entire paddle wheel rotates to begin filling the next empty section. Full sections of material are emptied into the fountain auger below for conveyance to a container. The material harvested is determined by multiplying the volume of sections on a paddle wheel by the number of paddle wheel revolutions.

Each of these flow sensors may provide flow data to a processing unit for analysis. The flow sensors or the processing unit may store historical data for analysis. The flow rate data may be stored for different types of material transferring components and different setups and used for the matching process described below. In an embodiment, different sensors on different machines include different sensor sensitivities. The differences in the type or operation of the sensors may lead to different delays or measured flow rates. As an example, there may be different type or lengths of delays for transferring from one type of component to another or even between similar machines with different manufacturers or different configurations. A length of a delay may also depend on the type of sensor.

The processing unit may store historical data related to flow rate in order to normalize or standardize new incoming data so that an accurate comparison may be made between machines. Certain methods may be more or less accurate than other methods. For example, metering grain flow sensing is more accurate than electromagnetic sensing, which is more accurate than acoustic sensing, etc. The processing unit may adjust or alter the flow rate data to accommodate the differences in methods and mechanisms used to acquire the flow rate data. Additional data may be acquired, such as data entered manually or from proximity sensors. The additionally acquired data may be stored and analyzed by the processing unit.

At act A120, the processing unit ranks possible matches between sources and destinations based on pattern matching of the acquired flow rate data for the plurality of sources and the plurality of destinations. Ranking may be based on a similarity of the acquired flow rate data. For example, when one machine loads material into another machine the flow rate data for both machines should be similar. The similarity may be a similarity of the shape the flow rate signals. For example, at the beginning of a transfer event the shape of the signal of a source may increase at the same rate as the signal of a destination increases after accounting for an expected delay and any difference in overall amplitude/magnitude or non-linearity. The magnitude of the signals may also be used to determine the similarity. In an embodiment, the processing unit may identify a type or configuration of a sensor and adjust the acquired flow rate data or matches accordingly. For example, certain sensors may be more or less accurate or more or less linear than other sensors. The accuracy and configuration of the sensors may be used to determine an expected delay or in ranking the matches.

In an embodiment, the processing unit only matches flow rate data that is related to one or more windows of time, for example the beginning and/or end of a transfer event. The pattern matching may also take into account expected changes due to machine travel and other normal variation not associated with an actual change in flow rate. If a change in flow rate for a location is detected above a fixed or dynamic threshold representative of the expected variation when the flow rate is not significantly changing, thus indicating a beginning or end of a transfer event, then a window of the flow rate measurements containing the change is matched against a window of measurements for each other flow rate sensor, offset by the expected delay between the two. For example, the processing unit may only attempt to match flow rate data from the beginning or the end of a transfer event. The fixed or dynamic threshold may be identified by calibrating or measuring the flow rate sensors. Different flow rate sensors may provide differently shaped signals. Different machines may exhibit different flow rates at the starting and ending events. As an example, the threshold for an optical sensor may be different than an acoustic sensor. If the sensor type is not known, the processing unit may be able to predict the type based on the shape of the flow rate signal and adjust accordingly. Historical data for each machine, sensor, or sensor type may be used to set the threshold or dynamic threshold.

To identify the beginning or end, a change value is calculated by the processing unit for each of the material flow rates. The change value is the change over time of the flow rate. As an example, the change value is positive for when the flow rate is increasing and negative for when the flow rate is decreasing. When the flow rate is steady, the calculated change value is equal to or close to zero. In an embodiment, the only portions of the flow rate data that may be used is the data from time periods (windows) from a flow rate of zero to non-zero and from non-zero back to zero. However, any significant change in flow rate may be used irrespective of the rate before the change.

Matches of the flow rate data may be performed using a pattern matching approach such as cross correlation, binary, or threshold-correlation. The matching is done after a change is detected and after enough time has elapsed to account for any expected delay plus, for example, the window. The elapsed time may include the delay plus half the window size after the start of the change.

The matches are ordered based on the quality or similarity of the match. In an example, the best matches are given the lowest ranking number, poorer matches are given high ranking numbers, and sensors without a match are given a ranking number that places the sensor at the highest ranking, e.g., the poorest ranking. The output is a list of possible matches between sources and destinations. In an embodiment, an ordinal ranking system is used to rank the matches. The non-matches are all assigned a rank of one larger than the worst match. Other ranking or scoring systems may be used that provide an indication that one match is better or worse (or equal) to other matches in generally a linear or monotonically increasing fashion. For example, a scoring system that provides a numerical score such as a similarity percentage may be used.

One method of determining the source and destination of a transfer event is by detecting the time-based correlation of transfer events by multiple machines. Detecting the time correlation of transfer events occurs when transfer events are detected by multiple machines within the same window of time within a predetermined tolerance. The tolerance may be dependent on the type of machines being used or the type of material. The tolerance may further be dependent on where the flow sensor is installed and how the flow sensor records data. The tolerance may be determined by running the system with a known configuration and measuring the differences in the time frames. The direction of the transfer may be identified via an initial configuration or setup of the type of equipment involved in the transfer and the types of transfers associated with the equipment type. The direction of the transfer may also be derived from when a change in flow rates starts and ends as a source may typically start and end before a destination.

In a simple example, if there is only one source and one destination and the time period for the flow changes matches up or is within a tolerance, then the two are matched and given a low ranking indicating that there is a high probability of a match. Since there is only one possible match in this scenario, this match will be assigned below at act A130. In a more complex example with multiple sources and destinations a similar method may be used if there are only certain pairs of sources and destinations for which the time period matches up. For example, with one source and two destinations (e.g., one cart, two trucks) the matches may be determined with a high level of certainty if each truck only matches up with a cart within different time periods. If, however, the setup or configuration of the equipment is not known, or multiple sources and destinations are concurrently transferring material, a pattern-matching method may be used to match machines based on the similarity of the shapes of the signals.

One method for matching the flow rate signals is to perform a cross correlation. A cross correlation provides a measure of the similarity of two signals as a function of the relative shift between the two. The processing unit identifies signals of two flow sensors. As discussed elsewhere, the windows of the signals are matched up given expected delays. A correlation is determined by multiplying the two signals together and accumulating the resulting signal. This provides a proxy for the similarity of two signals, as the more similar the two signals are, the larger the correlation is, assuming the amplitudes of the signals remain constant. A cross correlation is determined by shifting one signal through the other and determining the correlation for each amount of shift. The cross correlation provides a similarity measurement between signals as a function of the offset between the two. Selecting the signal pairs that have a maximum cross correlation at the expected offset maximizes the likelihood that the correct machine or storage location pair have been chosen. The cross-correlation signal has a length equal to the sum of the length of each signal minus one. A match between signals will be indicated by the cross correlation having a maximum within the center region of the cross-correlation signal, with the best overall match having the highest cross correlation within this region.

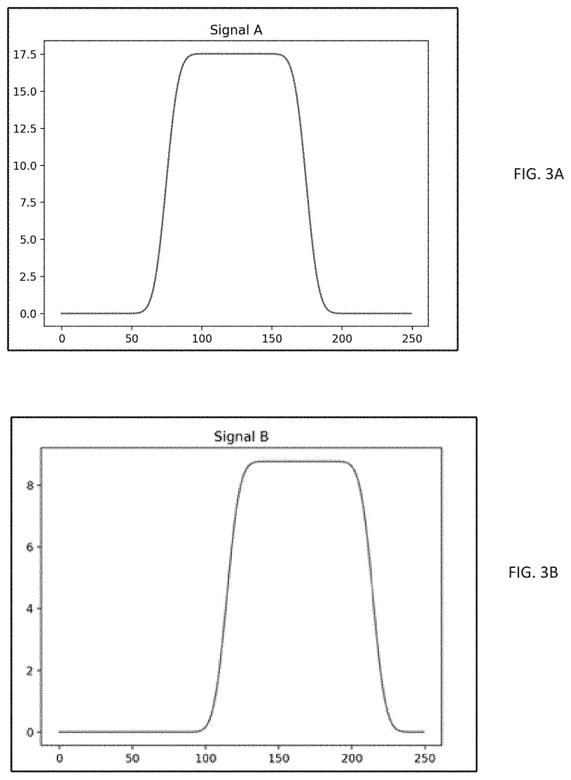

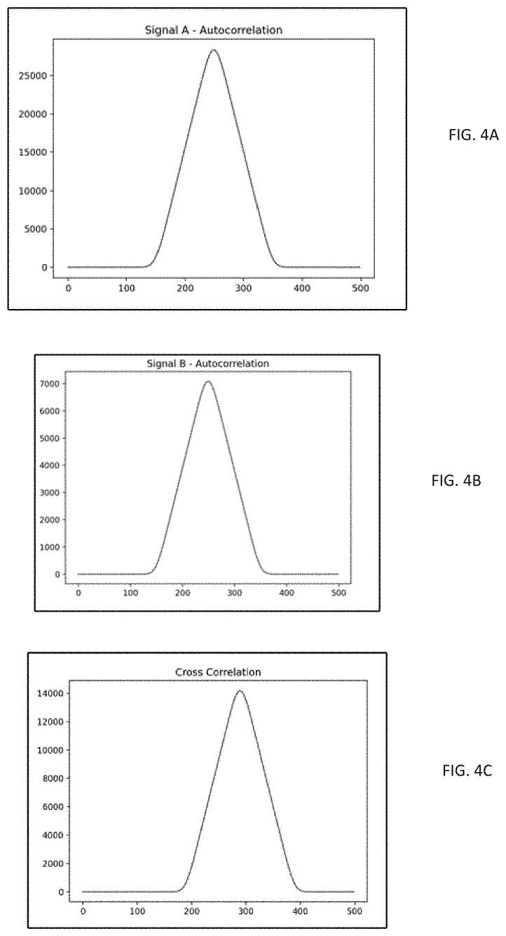

FIGS. 3 and 4 depict examples of performing a cross correlation between two signals. FIGS. 3A and 3B depict two example signals, A and B, where B is delayed by 50-time units relative to A. An autocorrelation is a cross correlation of a signal with itself. FIGS. 4A and 4B depict the autocorrelations of A and B with themselves. The x position represents the relative shift of the signal with itself, with a shift of zero being represented by center of the x data. For each signal, indeed for any non-zero signal, the maximum is in the center of the autocorrelation, as the shift of maximum alignment is zero when comparing a signal with itself or at offsets equal to exactly N periods of periodic signals, where N is any integer number.

FIG. 4C depicts the cross correlation of B with A. Signal B is delayed with respect to signal A by 50 positions, and accordingly the peak occurs 50 position after the center due to this delay. If the two signals represent the magnitude of flow rates of a pair of egress and ingress candidates, then the expected offset between the two signals is a function of the delay between when the changes in flow rate at the egress and ingress containers are visible. In the case of a grain cart transferring material from its container, the delay is the time it takes for the grain to fall from the end of the grain cart's auger into the grain truck or grain bagger. For a grain auger, such as a straight auger or swing-away auger, the delay is the time it takes for grain to travel through the entire length of the auger.

The portions of the flow rate signal that are most easily matched between flow sensors are the portions containing the largest variability. The portions may typically be found at the beginning and end of the transfer events. This is because the flow rate at the beginning of the event transitions from zero to the maximum/substantially continuous transfer rate and at the end it transitions from the transfer rate back to zero. In an embodiment, after the beginning of a transfer event has been detected, a window of the signal containing the beginning transition is used and cross correlated with a window of the signal of each of the other flow sensors, offset by an expected transfer delay. At the end of the transfer, another window may be used and the same analysis can be performed to validate that the correct pair of sensors were selected. However, it is possible a different sensor may be selected for the beginning and the end. Alternatively, the cross-correlation for the entire event may be done. The portions of the flow rate signal that are present in the middle of the transfer may also be used in addition to the starting and ending portions. During the transfer, the transfer rate between two containers may generally be constant, however, there may be slight changes in the rate that can be matched between a source and a destination. Depending on the type of sensor, these minor changes may be identified and used in the matching process.

If the flow of material is measured at either end of a conveyor, the delay between measurements may be inversely proportional to the revolutions per minute (RPM) of the conveyor. A calibration may be performed using a measurement of the time from when the grain first enters the auger until it first leaves, while concurrently measuring the RPM. After a calibration has been performed, the RPM may change while a transfer occurs and the signal may be adjusted by either changing the sampling interval or decimating or duplicating samples. For instance, if the RPM decreases by 10%, every 10th sample may be dropped to keep the signals time aligned. If the RPM increases by 10%, every 10th sample may be duplicated.

Depending on the installation and type of a flow sensor, the flow sensor may become covered in grain before the transfer is complete such that it cannot detect flow, and thus may cause a signal to fall before the transfer is complete, therefore affecting the correlation test at the end of the event. For this case, the signal ending earlier than expected may be acceptable, but not later than expected. Each of the beginning, end, and full transfer correlation measurements may be used on their own or in any combination to determine the flow sensors involved in the transfer event, and the optimum combination may depend on the specific implements involved with the transfer.

In an embodiment, the signals from multiple flow sensors may be summed before performing the cross correlation. This allows for the detection of transfer events involving either multiple sources, multiple destinations, or both. For example, if multiple grain carts unload into the same truck, the flow rates from the grain carts may be summed and the resulting signal cross correlated with the flow sensor in the truck.

In an embodiment, the maxima of the beginning and ending correlations for each pair of flow sensors is multiplied, summed linearly, summed on a vector basis, or otherwise combined, and the pair with the largest combination used as the match. These methods will allow different correlations to have more or less influence than others.

In an embodiment, the ranking may be biased towards more sensitive sensor data. Different machines and setups may use different sensors, each of which may include different configurations and, as such, certain sensor data may be more or less sensitive than other sensor data. The ranking may identify more sensitive sensor data erroneously. For example, the processing unit may wrongly select a machine with higher sensitivity when ranking matches that include two nearby combines (perhaps each with auger spouts oriented toward the same grain cart tank), each equipped with audio-based sensors, where the one used in the transfer has lower sensitivity than the other nearby. A calibration may be performed prior to ranking the matches. The calibration may normalize or standardize the data so that a fair comparison may be made. However, calibration may not be needed in many situations where the beginning and ending of transfers are matched through cross-correlation and there are no other machines nearby with super-sensitive sensors that might otherwise change the rankings.

Referring back to FIG. 3, at act A130, each source of the plurality of sources is assigned by the processing unit to one or more destinations of the plurality of destinations based on the ranked possible matches. If two or more transfers begin nearly simultaneously then there may be ambiguity regarding which machines were involved in the transfer. In other words, there may be multiple equally rated matches. If there is a tie or equally ranked matches, the system may use both the beginning and ending transitions. The choices may be ranked, and the sensor with the best overall rank considering both the beginning and ending correlations may be used. The ranking method prevents the cross-correlation magnitude from the beginning or end from having any more influence than the other as could occur if directly combining the cross-correlation results. Similarly, if multiple transfers begin and end simultaneously, the entire signal may be used to identify matches.

In an additional step, at act A140, the processing unit may calculate the amount of material transferred between each of the assigned sources and destinations. In an example, the flow rate is zero and then the flow rate change occurs. This point in time represents the beginning of a transfer. A flow rate accumulator used to track the total amount transferred may be enabled and initialized to the total flow accumulated since before the change began. If the flow rate is calculated from weight, volume, or another total measurement, as opposed to an accumulated measurement, the initial value would be a weight reading from before the change occurred, e.g. a reference or tare weight. Additionally, the ranking number for each flow sensor may be initialized to the results of the match. The flow sensor with the lowest ranking number will be associated with the flow sensor from which the change was detected. If the flow rate had not been zero before the change, then the same matching approach is followed. However, the accumulator is not reset and instead of initializing the ranking number for each sensor, the ranking numbers are incremented by or otherwise combined with the latest ranking number and the association is updated to the sensor containing the lowest total score. Combining the rankings may include incrementing, summing, or averaging the rankings. If the flow rate is identified as zero, this indicates the transfer has stopped. The total amount of material transferred (either the accumulator total or the difference in weight, volume or total between the beginning and end of the event) along with data identifying the associated flow sensors (or the containers to which the flow sensors are attached) is recorded, and the accumulator is stopped. If the flow rate is still non zero, this process repeats. Some parts of the system may not contain an accurate flow sensor, in which case the amount of the transfer may need to be inferred by tracking the elapsed time of a transfer, total auger rotations, or some other metric to apportion the accurate measurement between multiple containers.

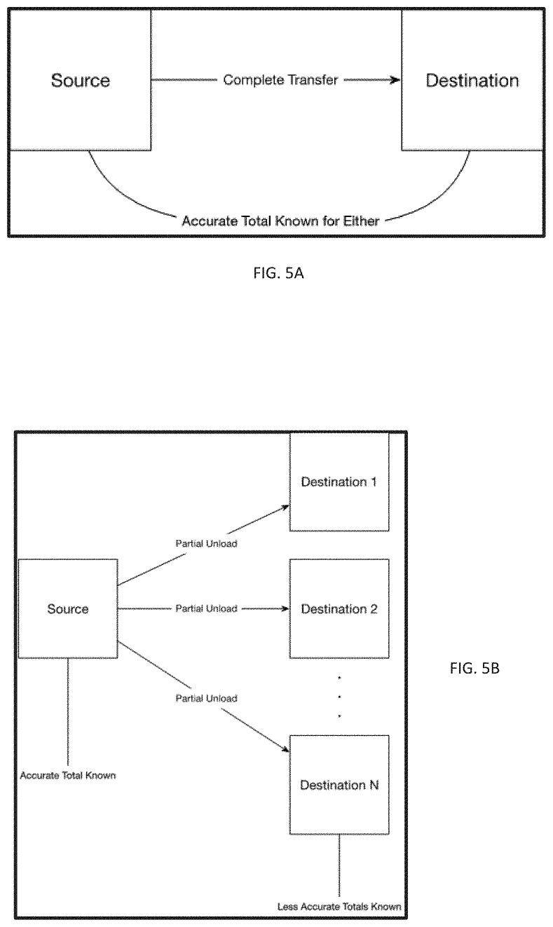

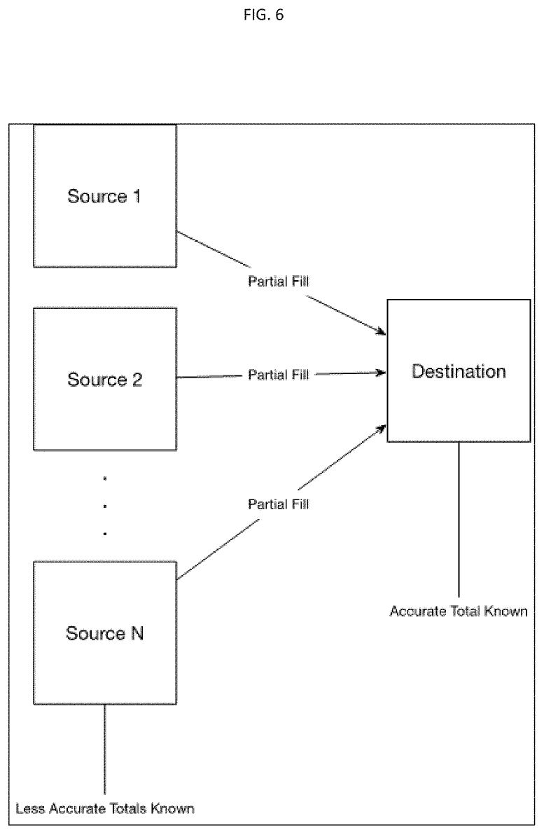

In an embodiment, low quality measurements may be reconciled with high quality measurements when measurements are related to each other based on the flow of grain. These relationships may be one-to-one, one-to-many, or many-to-one. A many-to-many flow can be decomposed into multiple many-to-one and one-to-many flows. A different strategy can be used for each of these scenarios as a way to maximize accuracy. Examples of these relationships are depicted in FIGS. 5A, 5B, and 6.

FIG. 5A depicts a One-to-One relationship. A one-to-one relationship occurs when a load of material goes from one source to one destination, and an accurate measurement is known for either the source or the destination based on a separate, more accurate reading. In this case, the more accurate reading overrides the less accurate one. This would be the case for when a truck unloads to a bin in one transfer, and the weight of the truck load was known from a previous measurement.

FIG. 5B depicts a One-to-Many relationship. A one-to-many relationship occurs when a single load is transferred to multiple locations and an accurate measurement for the total is known. The less accurate measurements can be used to divide the accurate measurement into portions while keeping the total equal to the more accurate reading. An example of this would be the case of a truck unloading into multiple bins, where the weight of the truck load is known from a previous measurement. The amount of the bin transfers can be used to divide the more accurate truck load into a portion for each bin.

FIG. 6 depicts a Many-to-One relationship. A many-to-one relationship occurs when many loads are transferred into a single location, and an accurate measurement for the total is known. In this scenario, the less accurate measurements can be used to divide the accurate measurement into portions while keeping the total equal to the more accurate reading. This would be the case with multiple combine harvester loads unloading into a grain cart before the grain cart unloads. The unload data is more accurate than the loads, as the grain cart is typically stationary while unloading. The amount of the combine harvester unloads can be used to divide the more accurate unload amount into separate loads, and still ensure the total is accurate.

The result of the method of FIG. 2 is an automated mechanism for recording how much material is transferred from one machine to another. The following describes multiple different scenarios that describe different types of event transfers for grain flow from combine harvesters, grain carts, trucks, grain baggers, and bins. The following example scenarios are described: a combine harvester unloading into a grain cart, a combine harvester unloading into a truck, a grain cart unloading into a truck or a grain bagger, a truck unloading into a bin, and a bin unloading into a truck. Additional or alternative containers or machines may be used. Different material or fluids other than grain may also be tracked through the transfer process. Each machine includes at least one flow sensor. Other sensors may also be used to provide additional data for measuring an amount of material transferred or may be combined with the flow rate data to provide additional information about which machines take part in the transfer events.

For a combine harvester unloading into a grain cart, the combine harvests grain and the grain is deposited in an integrated tank or a hopper. The combine harvester includes an unload auger that unloads the hopper into a vehicle such as a grain cart. If a flow sensor is attached to the unload auger of the combine harvester, the sensor produces a signal that increases as the flow rate through the auger increases, which occurs at the beginning of an unload event. The combine harvester unloads into a mobile wagon with an integrated unload auger called a grain cart. If the grain cart has a built-in scale, the flow rate may be determined by calculating the equivalent of a derivative of the weight signal such as by successive differencing. The flow rate increases at the beginning of the unload event. There is a delay between the two flow rate signals which, depending on the location of the sensor, may represent the time it takes the grain to fall from the auger into the grain cart's tank. When a significant increase in the grain cart weight is detected, a cross correlation is performed for signals in a window of the grain cart flow rate signal and signals in similar windows for other combine harvester flow sensors in the same period of time. For each sensor a cross correlation is calculated where a maximum occurring within a window offset by the expected delay is selected and then ranked based on the magnitude of the maximum. The minimum rank number (largest maximum) is used to identify the combine harvester involved in the transfer. When the grain cart's weight stops increasing, the cross correlation is repeated and each combine harvester's rank number is incremented by or otherwise combined with the newest rank number. The lowest total rank number is used to identify the combine harvester used. The identification is recorded along with the weight filled (the difference in weight before and after the fill), and data identifying the grain cart, current field, or both.

For a combine harvester unloading into a truck, a scale is not typically involved. For this scenario, the flow signals may be analyzed to detect change in flow, rather than analyzing the derivative of the weight signal. All other steps are as described above, but the weight transferred may not be available due to the lack of an accurate flow measurement. As a substitute other metrics may be recorded, such as the time duration of the unload, the number of auger revolutions, or an accumulated quantity related to the flow sensor output.

For a grain cart unloading into a truck or grain bagger, if a flow sensor is attached to the tank of the truck trailer or bagger hopper, the sensor produces a signal that increases as the flow rate through the grain cart increases, e.g., at the beginning of an unload event. After a significant decrease in the grain cart weight is detected, a cross correlation is performed between the grain cart flow rate signal and similar windows for all other truck or grain bagger flow sensors seen in the same period of time. For each one the maximum cross correlation over a small window covering the expected delay will be calculated. The ranking of matches is based on the maximum cross correlation. A minimum rank number will be used to identify the truck or bagger involved in the transfer. When the grain cart weight has stopped decreasing, the cross correlation is repeated and each grain bagger's rank number is incremented by or otherwise combined with the newest rank number. The lowest total rank number is used to identify the grain bagger used and this is recorded along with the weight unloaded (the difference in weight before and after the unload), and data identifying the grain cart, current field, grain bagger or truck, or any other combination.

A truck unloading into a bin is similar to a combine harvester unloading into a truck, as neither the truck nor bin typically includes a scale installed. If a flow sensor is attached near the exit gate(s) of the truck and another near the opening of the grain bin, the truck and bin can be matched. Furthermore, the auger rpms may be monitored to more accurately predict the delay between changes in flow rate between the truck and bin. This allows for the truck and bin to be matched, but does not support an accurate measurement of the weight of grain unloaded. However, the weight may be inferred if the transfer into the truck contained an accurate weight. This same weight will generally transfer entirely to one bin, but will occasionally be split between multiple bins, such as after a bin has been filled. In this case, measurements such as auger rpm, total auger rotations, operational time, auger angle, total flow time, etc. can be used to estimate the fraction of the total weight that should be assigned to each bin. In in this way, lower quality measurements can be used to apportion a high-quality measurement.

A bin unloading into a truck is similar to the truck unloading into a bin, but in reverse. If a flow sensor is attached near the exit gate or door of the bin, and another inside the tank of the truck, the truck and bin can be matched. The auger may be instrumented to monitor the rpm for predicting the expected delay. Different sized augers may cause significantly different delays. For the cross-correlation technique, a window may be sized that is larger than normal depending on the configuration. As the delay may be extensive, matching may be less accurate for both a start and a stop. The weight will not generally be available, but other measurements as described in the truck-to-bin example may be used to apportion a high-quality measurement available after the truck has unloaded to a grain terminal. Alternatively, the bin may unload into a grain cart equipped with scales in order to provide an accurate measurement.

FIG. 7 depicts an example system 700 for tracking material transfers between commodity handling components 701a-d. The system 700 is configured to make simultaneous flow rate measurements from multiple commodity handling components 701a-d, detect changes in flow rates for those commodity handling components 701a-d, and determine the commodity handling components 701a-d involved in the transfer by finding the commodity handling components 701a-d with the flow rate changes most similar in signal shape.

The system includes a plurality of commodity handling components 701a-d comprising source components 701a and 701b and destination components 701c and 701d involved in a transfer of material, each of the source components 701a,b and destination components 701c,d including at least a flow sensor 702 and a transmitter 704. The system further includes a controller 705 that may be referred to as a processing unit 705. The controller 705 includes at least a memory 711, a computer processor 715, and a communications interface 713. The controller 705 may include or be part of a computer, remote server, workstation, cloud-based system, tablet, or other system. Additional, different, or fewer components may be provided. For example, an electronic communications network 750 is included for communicating data from the controller 705 to the components 701a-d and/or to a remote processing or storage device. As another example, a user input device (e.g., keyboard, buttons, sliders, dials, trackball, mouse, microphone, or other device) may be included with the controller 705.

As described in more detail below with respect to FIG. 9, the flow sensors 702 use sensors that produce a signal that varies with flow rate of a material that is transferred into or out of a respective commodity handling component. The controller 705 receives one or more of these signals in order to detect changes in flow rates, and match these changes between flow sensors 702 to determine the path the material is taking between the plurality of commodity handling components 701.

The controller 705 may include a general processor 715, digital signal processor, an application specific integrated circuit (ASIC), field programmable gate array (FPGA), analog circuit, digital circuit, combinations thereof, or other now known or later developed processor. The controller 705 may be a single device or combinations of devices, such as associated with a network, distributed processing, or cloud computing.

The memory 711 may include one or more of a read only memory (ROM), random access memory (RAM), a flash memory, an electronic erasable program read only memory (EEPROM), or other type of memory. The memory 711 may be removable from the controller 705, such as a secure digital (SD) memory card.

The controller 705 may also include a display 717 that is configured to display a user interface. The display 717 may be or include a CRT, LCD, projector, plasma, printer, tablet, smart phone or other now known or later developed display device for displaying the output of the controller 705.

The controller 705 includes a communications interface 713. The communications interface 713 may include a receiver and transmitter (or for example, a transceiver). Communication between the controller 705 and the components 701a-d and/or flow sensors 702 of the plurality of commodity handling components 701 is performed using the communications interface 713. Communications between the components 701a-d and the controller 705 may be in continuous communication for real-time, or non-continuous/batch/periodic communication for non-real time. The controller 705 may also communication to other devices using the communications interface 713. The communications interface 713 may include any operable connection. An operable connection may be one in which signals, physical communications, and/or logical communications may be sent and/or received. An operable connection may include a physical interface, an electrical interface, and/or a data interface. The communications interface 713 may provide for communications over a network 750 using wired networks, wireless networks, or combinations thereof. The wireless network may be a cellular telephone network, LTE (Long-Term Evolution), 4G LTE, a wireless local area network, such as an 802.11, 802.16, 802.20, WiMAX (Worldwide Interoperability for Microwave Access) network, DSRC (otherwise known as WAVE, ITS-G5, or 802.11p and future generations thereof), a 5G wireless network, or wireless short-range network such as Zigbee, Bluetooth Low Energy, Z-Wave, RFID and NFC.

The controller 705 is configured to receive flow rate data from the plurality of commodity handling components 701. The flow rate data is collected by sensors 702 embedded or associated with each commodity handling component 701. The controller 705 analyzes the flow rate data to identify beginnings and endings of each transfer event for the plurality of commodity handling components 701. The controller 705 is configured to rank each pair of sources and destinations (or each pair of commodity handling components 701 if the source/destination data is unknown) based on how similar the flow rate data is for each component 701 during a window of time around the beginning and ending of the transfer events. The controller 705 is configured to select or assign pairs of components 701 based on the ranking and calculate a total amount of material transferred.

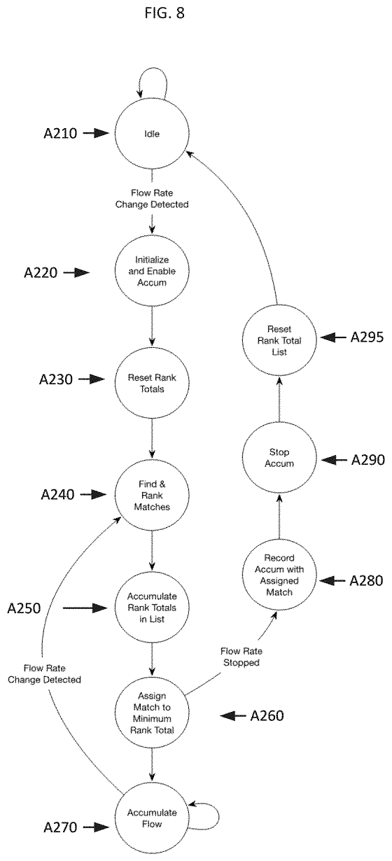

FIG. 8 depicts states, and transitions therebetween, of the controller 705 for a process to detect and associate flow sensors 702 involved in a transfer event. The following describes each state and transition. At the Idle or initial state A210, the controller 705 remains in idle until a flow rate change is detected, after which it transitions to Initialize and Enable Accumulator A220.

At the Initialize and Enable Accumulator state A220, a flow rate accumulator is initialized to a measurement representing a total volume or weight before the flow rate change in the case of a system with onboard weighing, or to the accumulation of the flow rate from before the change to the point at which the change was detected when onboard weighing is unavailable. After initialization it transitions to Reset Rank Totals A230.

At the Reset Rank Totals state A230, the controller 705 resets the rank total tracked for each flow sensor 702, after which it transitions to Find and Rank Matches A240.

At the Find and Rank Matches state A240, the controller 705 performs a cross correlation with all flow sensors 702 other than the sensor 702 from which the change was detected. Each cross correlation containing a maximum within a window centered around the expected offset will be considered, and the magnitude of the peak relative to the minimum will be calculated, and the sensors will be ranked ordinally based on this calculation, with the best match assigned a rank of zero. Any sensor 702 not considered will be assigned rank of one larger than the highest considered rank. After this calculation, the state machine transitions to Accumulate Rank Totals in List A250.

At the Accumulate Rank Totals in List state A250, the controller 705 increments or otherwise combines the existing rank totals (which may be zero after they are reset) by or with the new rank totals, after which it transitions to Assign Match to Minimum Rank Total A260.

At the Assign Match to Minimum Rank Total state A260, the controller 705 assigns the flow rate match to the sensor containing the minimum rank total. If the flow rate is now zero, the state transitions to Record Accumulator with Assigned Match A280. If the flow rate is non-zero, the state transitions to Accumulate Flow A270.

At the Accumulate Flow state A270, the controller 705 remains in this state until a change is detected, and the flow accumulator advances either by calculating the difference between the current total volume or weight and the accumulator's initialized value in the case of a system with onboard weighing, or by accumulating the flow measurements from the sensor 702 from which the change is detected when onboard weighing is unavailable. If a change is detected, then the state transitions to Find and Rank Matches A240.

At the Record Accumulator with Assigned Match state A280, the controller 705 records the assigned match along with the accumulator as well as other available data such as date, time, location, etc., after which is advances to Stop Accumulator A290.

At the Stop Accumulator state A290, the controller 705 stops the flow rate accumulator, after which is advances to Reset Rank Total List A295.

At the Reset Rank Total List state A295, the controller 705 resets the rank total lists, after which it advances to Idle A210.

The result of the process is an identification of the components 701 involved in one or more transfer events and a calculated amount of material transferred during such. The controller 705 may be configured to store the received and analyzed data in the memory 711. The controller 705 may also be configured to present the data to a user using the display 717 or user interface or transmit the data to the cloud or other computer device through the network using the communications interface 713. The controller 705 communicates with each of the flow sensors 702 using the network.

The flow sensor 702 may be any device that is configured to acquire flow rate data from the plurality of commodity handling components 701. The flow sensor 702 acquires data and transmits the data to the controller 705. The flow sensor 702 may be configured as any type of sensor.

In an embodiment, the flow sensor 702 is configured as a sensor that uses vibration and/or acoustic data to determine when grain is flowing in or out of the container, or through the auger to which it is attached. Data corresponding to these sensor types is detected and advertised. Receiving devices, such as the processing unit or controller 705 may use these measurements along with knowledge of the type of machine to which the flow sensor 702 is attached to determine whether material (e.g., grain) is flowing in or out of the specific machine associated with the advertised data. The flow sensor 702 may collect the flow data and hold on to it until a later time when it is provided to the controller and analyzed. The controller 705 and flow sensor(s) 720 may function in real-time or as a non-real time post-harvest process to figure out details of all of the transfers occurring over a past/historical time period.

When grain is transported from one location to another, either through gravity or a conveyor, each kernel of grain will create an impulse of energy when it strikes a container or pile of grain. The frequency spectrum of a perfect impulse is wideband, meaning it contains equal intensity at all frequencies. A kernel of grain does not create a perfect impulse, but does contain significant high-frequency components. A stream of kernels causing impulses at random times results in an acoustic signature resembling white noise, which sounds like a hiss. These high frequency components may be used to distinguish the grain flow signature from other lower-frequency components generated by farm machinery. By orienting a microphone such that it is sensitive to this sound, and analyzing the high frequency content of this signal, an easy-to-use contactless grain flow sensor 702 can be developed. The spectral power will increase with the flow rate, though it may not be accurate enough to determine an accurate measurement of the flow rate itself. However, this still allows for techniques such as flow rate correlation with other sensor as a way of determining the machines involved in a transfer as described above. Additionally, the acoustic signal can be divided into multiple frequency bands in the audio range. By performing periodic measurements of the frequency content, such as by using a fast Fourier transform (FFT), the spectrum can be divided into bands, and the power or signal level in each band can be treated as a separate flow sensor 702. This allows any one band to be used to detect changes in flow rate, and to be used as a potential correlation match. By analyzing frequencies above 4 kHz, voice and most machinery noise can be rejected. The upper bandwidth may range from 10 kHz to 20 kHz depending on the microphone, but an overall bandwidth of 4 kHz to 10 kHz, divided into multiple bands, provides a good range for detecting grain flow. Other frequencies, such as outside the audio band may be used. An accelerometer may be optionally used as a contact microphone to sense grain flow directly, when the flow sensor 702 mounted within the grain flow path, or attached to a surface directly or indirectly within the grain flow path.

FIG. 9 depicts an example of a flow sensor 702. The flow sensor 702 includes a processor 715, a memory 908, a transceiver 704, an accelerometer 902, a microphone 906, a programmable preamp 904, and a battery. Additional, different, or fewer components may be provided.

The processor 715 is configured for analysis of the signals from the accelerometer 902 and microphone 906. The memory 908 is configured for data storage and firmware image storage, used by over-the-air updates. The memory 908 may store and hold on to the acoustic or flow data until a later time. The transceiver 704 is configured to provide communications over a network. In an embodiment, the transceiver 704 is a Bluetooth LE Radio Transceiver. The accelerometer 902 is configured to detect high frequency vibration caused by falling grain, either from directly or indirectly conducted vibration. The accelerometer 902 may also be used to detect low frequency, periodic vibration, such that produced by a grain auger. The frequency of this vibration may be detected by performing an FFT of the signal and detecting the lowest non-zero dominant frequency. Alternatively, an autocorrelation of the signal may be first performed to emphasize the periodicity of the signal and the frequency of this may be measured either in the time domain or by using an FFT. The microphone 906 is configured to detect high frequency acoustic vibration 910 caused by falling grain. The microphone 906 may be configured to wake up the controller 705 when noise is detected as a way to conserve power and maximize battery life. The preamp 904 is configured to amplify the microphone 906 output so that the microphone 906 output may be converted by the controller's 705 analog to digital converter. The preamp 904 includes a programmable gain so that the signal to noise ratio may be maximized while still preserving adequate dynamic range. The battery is used to provide power to the system.

In operation, when a container supports integrated weighing capability, such as with onboard scales, flow in (ingress) or out (egress) of the container may be detected by detecting an increase or decrease of weight. The flow sensor 702 is configured to monitor the flow of grain into or out of container where onboard weighing is not provided, or it is difficult to determine whether weight is increasing or decreasing due measurement dynamics from the motion of the container. Ingress flow is detected by positioning the flow sensor 702 inside a container and orienting it such that the microphone 906 responds to the sound of grain arriving in the container. Egress flow is generally detected by positioning the flow sensor 702 near the location where the grain is discharged and orienting it such that the microphone 906 responds to the sound of grain arriving at the receiving hopper or container. An individual flow sensor 702 is generally configured or associated with either ingress or egress transfers, though there may be cases whether a single flow sensor 702 can detect both ingress and egress. The following lists examples of storage containers where the flow sensors 702 can be located in the traditional grain harvest flow.

Combine—Ingress: the flow sensor 702 supports detection of a combine hopper being filled by attaching it to the inside of the combine hopper with the microphone 906 directed downward to detect the sound of grain striking the combine hopper.

Combine—Egress: the flow sensor 702 supports detection of a combine hopper being unloaded by attaching it to the end of the discharge auger with the microphone port directed downward to detect the sound of grain striking the grain cart tank or grain truck trailer. The accelerometer 902 will detect the operation of the auger and the microphone 906 will detect the flow of grain. By detecting auger operation separately from grain flow, the system can determine whether the combine hopper was completely unloaded or unloading was stopped beforehand. If the hopper is completely unloaded, the grain flow will cease before the auger stops; otherwise, they stop nearly simultaneously. If the previously load was completely unloaded, the auger will start before the grain flow starts; otherwise, they start nearly simultaneously.

Grain Cart—Ingress: the flow sensor 702 supports detection of grain filling a grain cart by attaching it to the inside of each grain cart tank with the microphone 906 directed downward, preferably at the top in a corner so that the sound of the grain pouring in the tank can be detected and the chance of being covered in grain is minimized.

Grain Cart—Egress: the flow sensor 702 supports detection of a grain cart tank being unloaded by attaching it to the end of the discharge auger with the microphone port directed downward to detect the sound of grain striking the grain truck trailer or grain bagger. The accelerometer 902 will detect the operation of the auger and the microphone 906 will detect the flow of grain.

Grain Truck—Ingress: the flow sensor 702 supports detection of grain filling a grain truck by attaching it to the inside of each grain truck box or trailer with the microphone 906 directed downward, preferably at the top in a corner so that the sound of the grain pouring in the truck can be detected and the chance of being covered in grain is minimized.

Grain Truck—Egress: the flow sensor 702 supports detection of grain exiting a truck by attaching it near the grain trailer hopper discharge or end gate with the microphone 906 directed downward to detect the sound of grain striking an auger hopper or elevator pit.

Grain Bagger Hopper—Ingress: the flow sensor 702 supports detection of grain cart filling a grain bagger by attaching it to the inside of each grain bagger hopper with the microphone 906 directed downward, preferably at the top in a corner so that the sound of the grain pouring in the truck can be detected and the chance of being covered in grain is minimized.

Grain Bagger Hopper—Egress: egress detection for grain baggers is not necessary, as baggers fill grain bags as they are being filled.

Grain Bin—Ingress: the flow sensor 702 supports the detection of grain filling a bin by attaching it near the lid with the microphone 906 configured to detect the sound of grain arriving in the bin and/or scraping inside the auger spout.

Grain Bin—Egress: the flow sensor 702 supports detection of grain exiting a bin by attaching it near the hopper discharge of a hopper-bottomed bin or the door of the flat-bottomed bin with the microphone 906 directed downward to detect the sound of grain striking an auger hopper or the sound of the auger operating or the grain running through the auger.

Seed Tender—Ingress: the flow sensor 702 supports detection of grain filling a seed tender by attaching it to the inside of each seed tender tank with the microphone 906 directed downward, preferably at the top in a corner so that the sound of the grain pouring in the tank can be detected and the chance of being covered in grain is minimized.

Seed Tender—Egress: the flow sensor 702 supports detection of a seed tender tank being unloaded by attaching it to the end of the discharge conveyor with the microphone port directed downward to detect the sound of grain arriving in the planter or air seeder tank.

Planter—Ingress: the flow sensor 702 supports the detection of grain filling a Planter by attaching it near the tank's opening with the microphone 906 configured to detect the sound of grain arriving in the tank.

Planter—Egress: egress detection for planters is not necessary, as the grain is planted in the field.

Air Seeder Cart—Ingress: the flow sensor 702 supports the detection of grain filling an air seeder cart by attaching it near the tank's opening with the microphone 906 configured to detect the sound of grain arriving in the tank.

Air Seeder Cart—Egress: egress detection for air seeder carts is not necessary, as the grain is seeded in the field.

Grain Auger—Ingress: the flow sensor 702 supports the detection of both operation of and grain flowing through a grain auger by mounting it with the microphone 906 directed downward toward the hopper, so that the sound of grain pouring into the hopper can be detected. Additionally, the accelerometer 902 can be used to detect that the auger is operating.

Grain Auger—Egress: egress detection for grain augers is not necessary, as augers empty as they are being filled subject to the delay associated with the travel time through the auger tube.

Transfer Detection—a transfer is detected by matching an egress event with an ingress event. However, not all transfers are possible based on the physical geometries of the machines involved. The following is a nonexclusive list of the types of machines that may be associated with a transfer and the supported direction of that transfer: Combine to Grain Cart; Combine to Grain Truck; Combine to Grain Bagger; Grain Cart to Grain Truck; Grain Cart to Grain Bagger; Grain Cart to Grain Cart; Grain Truck to Bin; Bin to Bin; Bin to Truck; Bin to Grain Cart; Bin to Seed Tender; Seed Tender to Planter; and Seed Tender to Air Seeder.

In an embodiment, when multiple pieces of machinery are used in the same area, such as two grain carts unloading into trucks in the same field, or multiple trucks unloading into bins in the same bin yard, a real-time mechanism may be employed to ensure the correct set of equipment is associated with each transfer. By announcing to all machines within wireless range when two flow sensors 702 are currently associated with a transfer, it prevents those flow sensors 702 from being erroneously associated with another current transfer. When an egress event is detected and a matching unassociated ingress event is detected, the two events may associate on a first-come-first-serve basis and the status of the association can be announced to all equipment within wireless range. The matching ingress flow sensor 702 may be found through time flow rate correlation as describe above or, or by choosing the unassigned flow sensor 702 with the largest acoustic signature. The announcement prevents any other equipment from incorrectly associating a subsequent transfer with either of these machines. When the transfer is complete, the association is broken and that status is announced so each machine is again available for association with a future transfer.

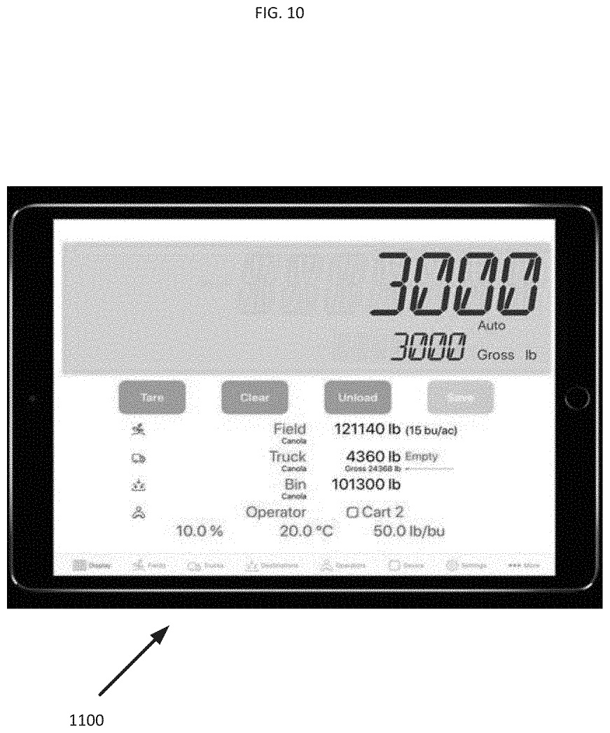

FIG. 10 depicts an example user interface for the display 717 of the system of FIG. 7. The display 717 is coupled to the processor 715 and the memory 711 and is configured to display information using the user interface about which components 701 are involved in a transfer event along with an amount or total amount of material that is transferred.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the described embodiments should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

1. A computer implemented method for calculating a path of material transferred between a plurality of sources and destinations in a commodity handling system, the method comprising:
acquiring, by a controller, material flow rate data for the plurality of sources and destinations;
ranking, by the controller, candidate matches between sources and destinations based on pattern matching of the material flow rate data for the plurality of sources and the plurality of destinations; and
assigning, by the controller, one or more sources of the plurality of sources to one or more destinations of the plurality of destinations based on the ranked candidate matches.

2. The computer implemented method of claim 1, further comprising:
calculating, by the controller, an amount of material transferred between the assigned sources and destinations.

3. The computer implemented method of claim 1, wherein the material flow rate data is measured by flow rate sensors coupled with each of the plurality of sources and destinations, wherein the material flow rate data is wirelessly transmitted to the controller.

4. The computer implemented method of claim 3, wherein the flow rate sensors are configured for measuring a signal related to the material flow rate, the signal including at least one of a force plate measurement, a change in weight of an onboard scale, a vibrational sensor measurement, a beam pattern, or a sound level, wherein the signal is transmitted to the controller.

5. The computer implemented method of claim 1, wherein pattern matching comprises calculating a similarity in a shape of a flow rate signal in the material flow rate data for the candidate matches.

6. The computer implemented method of claim 1, wherein pattern matching comprises:
calculating a change in material flow rate for the material flow rate data for one of the respective sources and respective destinations;
identifying an expected delay due to sensor configuration; and
matching, when the change in the material flow rate is detected above a threshold, a window of the material flow rate data containing the change against a window of material flow rate data for each other of the respective sources and respective destinations, offset by the expected delay between the respective sources and respective destinations.

7. The computer implemented method of claim 6, wherein matching comprises:
cross correlating material flow rate data for the windows of each of the respective sources and respective destinations.

8. The computer implemented method of claim 6, wherein the windows correspond to a window of time related to a beginning or ending of a transfer event.

9. The computer implemented method of claim 1, wherein the sources and destination comprise at least one of a combine harvester, a grain cart, a grain truck, a grain bagger, a swing-away auger, or a grain bin.

10. A system comprising:
a plurality of commodity handling components comprising source components and destination components that may be involved in a transfer of material, each of the source components and destination components including at least a flow sensor configured to acquire flow rate data for the transfer of material into or out of a respective source component or a respective destination component, each flow sensor comprising a transmitter configured to transmit the flow rate data to a processor coupled with a memory;
the memory configured to store the flow rate data; and
the processor configured to:
rank candidate matches between source components and destination components based on a similarity of a shape of flow rate data signals; and
match each source component to a destination component based on the ranked candidate matches.

11. The system of claim 10, wherein the processor is further configured to calculate an amount of the material transferred between each of the matched source components and destination components of the commodity handling components

12. The system of claim 10, further comprising:
a display coupled with the processor, the display configured to display the amount of material transferred between each of the respective source components and destination components.

13. The system of claim 10, wherein the processor is further configured to identify a beginning and ending of a transfer event, wherein the processor is configured to rank the candidate matches based on the similarity of the flow rate data for at least one of the beginnings and endings of each combination of respective source components and destination components taking into account an expected delay caused by flow sensor configurations in each of the respective source components and destination components.

14. The system of claim 13, wherein the processor is further configured to identify the beginning and ending of a transfer event by calculating a change value in flow rate from the flow rate data, wherein a change in flow rate for a location that is above a threshold is identified as part of a beginning or ending of a transfer event.

15. The system of claim 13, wherein the processor is further configured to rank candidate matches based on a similarity of a cross correlation of the flow rate data for at least one of the beginnings and endings of each combination of respective source components and destination components adjusting for an expected delay caused by flow sensor configurations in each of the respective source components and destination components.

16. The system of claim 15, wherein the processor is further configured to identify the beginning and ending of a transfer event by calculating a change value in flow rate from the flow rate data, wherein a change in flow rate for a location that is above a threshold is identified as part of a beginning or ending of a transfer event.

17. The system of claim 10, wherein the plurality of commodity handling components comprises at least one of a combine harvester, a grain cart, a grain truck, a grain bagger, a swing-away auger, or a grain bin, wherein the material comprises grain.

18. The system of claim 10, wherein the flow sensors are configured for measuring a signal related to material flow rate, the signal including at least one of a force plate measurement, a change in weight of an onboard scale, a vibrational sensor, a change in a beam pattern, or a sound level.

19. A computer implemented method for identifying a path of material transferred between a plurality of sources and a plurality of destinations involved in the transfer of material, the method comprising:
acquiring, by a processor, flow rate signal data for the plurality of sources and plurality of destinations;
identifying one or more periods in the flow rate signal data that exceed a threshold change value;
ranking a similarity of a shape of the flow rate signal data in the one or more periods for the plurality of sources and plurality of destinations; and
assigning one or more sources of the plurality of sources to one or more destinations of the plurality of destinations based on the ranking.

20. The computer implemented method of claim 19, further comprising:
calculating an amount of material transferred between each combination of assigned sources and destinations.
